(19) United States
(12) Patent Application Publication
(10) Pub. No.: US 2015/0066436 A1
(43) Pub. Date: Mar. 5, 2015

(54) KINETIC DECONVOLUTION OPTICAL RECONSTRUCTION METHOD

(71) Applicant: London Health Sciences Centre Research Inc., London (CA)

(72) Inventors: Jonathan Thomas Elliott, London (CA); Keith St. Lawrence, London (CA); Mamadou Diop, London (CA); Ting-Yim Lee, London (CA); Kenneth M. Tichauer, West Lebanon, NH (US)

(21) Appl. No.: 14/382,151

(22) PCT Filed: Mar. 4, 2013
(86) PCT No.: PCT/CA2013/000202

§ 371 Date: Aug. 29, 2014

Related U.S. Application Data
(60) Provisional application No. 61/606,346, filed on Mar. 2, 2012.

(51) Int. Cl. G06T 7/00

(52) U.S. Cl. CPC G06T 7/00
USPC 702/189

(57) ABSTRACT

A method of determining dynamic parameters for a plurality of sub-regions within an interrogation region comprises processing optical image data and measurements of a concentration of contrast agent entering each of the sub-regions to determine a flow-scaled impulse residue function for each of the sub-regions, and calculating dynamic parameters for each sub-region from a respective flow-scaled impulse residue function.

### CROSS-REFERENCE TO RELATED APPLICATION

This application claims the benefit of U.S. Provisional Application No. 61/606,346 to Elliot et al. filed on Mar. 2, 2012, the entire disclosure of which is incorporated herein by reference.

### FIELD OF THE INVENTION

The present invention relates to imaging and in particular, to optical imaging.

### BACKGROUND OF THE INVENTION

Dynamic contrast-enhanced (DCE) techniques are used in biomedical optics to measure tissue dynamic parameters such as for example blood flow (F), blood volume (BV), and mean transit time (MTT) [1]. Analogous to DCE methods for computed tomography (CT) and magnetic resonance (MR) imaging, the methodology requires injecting a contrast agent (CA) into the subject, recording the time-dependent signal change, and applying non-parametric modeling to extract the dynamic parameters.

If the region being interrogated is considered homogeneous, such as measuring cerebral hemodynamics in a newborn by near-infrared spectroscopy (NIRS) [1], then converting the optical signal into DCE data is straightforward. However, if the region being interrogated is heterogeneous such as an adult head or tomographic imaging of small animals, converting the optical signal into DCE data requires a two-step (TS) method. As in CT and MR imaging, the TS method involves reconstructing a time series of DCE images to determine the change in contrast agent in each image sub-region, followed by applying nonparametric modeling such as deconvolution to the obtained concentration curve of each image sub-region to determine dynamic parameters thereof [2]. For example, DCE data from the adult brain could be isolated using moment analysis of time-resolved NIRS [3]. In another application, a series of DCE fluorescence molecular tomography (FMT) concentration maps are used to obtain dynamic information about a region of interest (ROI) [4]. Unlike CT or MR imaging, extracting dynamic parameters from optical measurements is ill-posed [5].

The first step of the TS method, namely reconstructing the optical image data to produce a time series of DCE images representing the change in contrast agent in each imaged sub-region, is mathematically ill-posed due to the uncertainty of a sensitivity function, A as the sensitivity function A is a representation of the probability of a photon interacting with a particular imaged sub-region. Thus, there are many potential solutions when determining the change in contrast agent in each imaged sub-region. With the addition of random system noise, it is difficult to differentiate between the potential solutions.

Improvements in optical image data processing are generally desired. It is therefore an object at least to provide a novel method and apparatus for processing optical image data to determine dynamic parameters.

### SUMMARY OF THE INVENTION

Accordingly, in one aspect there is provided a method of determining dynamic parameters for a plurality of sub-regions within an interrogation region, the method comprising processing optical image data and measurements of a concentration of contrast agent entering each of the sub-regions to determine a flow-scaled impulse residue function for each of the sub-regions, and calculating dynamic parameters for each sub-region from a respective flow-scaled impulse residue function.

In an embodiment, the optical image data is captured upon injection of a contrast agent. The optical image data comprises generating at least one of an equality constraint and an inequality constraint. The at least one equality constraint comprises at least one of assuming the flow-scaled impulse residue function is equal to zero prior to any portion of the contrast agent reaching a respective sub-region, and assuming the flow-scaled impulse residue function is equal to one prior to any portion of the contrast agent exiting the respective sub-region. The at least one inequality constraint comprises assuming that the flow-scaled impulse residue function will decrease after any portion of the contrast agent exits the respective sub-region.

In an embodiment the dynamic parameters comprise at least one of blood flow, blood volume and mean transit time.

In an embodiment the contrast agent is a targeted tracer. The dynamic parameters comprise kinetic parameters. The kinetic parameters comprise at least one of a rate constant governing the extraction of the targeted tracer into an interstitial space, vascular leakage kinetics and binding kinetics.

According to another aspect there is provided a non-transitory computer readable medium embodying a computer program for execution by a computer to determine dynamic parameters for a plurality of sub-regions within an interrogation region, the computer program comprising program code for processing optical image data and measured concentrations of a contrast agent entering each of the sub-regions to determine a flow-scaled impulse residue function for each of the sub-regions, and program code for calculating dynamic parameters for each sub-region from a respective flow-scaled impulse residue function.

According to yet another aspect there is provided an apparatus for determining dynamic parameters for a plurality of sub-regions within an interrogation region comprising memory embodying computer program code, and processing structure, the processing structure communicating with the memory, the computer program code when executed by the processing structure causing the apparatus at least to process optical image data and measurements of a concentration of contrast agent entering each of the sub-regions to determine a flow-scaled impulse residue function for each sub-region, and calculate dynamic parameters for each sub-region from a respective flow-scaled impulse residue function.

### BRIEF DESCRIPTION OF THE DRAWINGS

Embodiments will now be described more fully with reference to the accompanying drawings in which:

FIG. 1 shows an exemplary construction of a time-density curve as a convolution between the concentration of contrast agent entering an interrogation region and a flow-scaled impulse residue function;

FIG. 2 is a flowchart showing input and output values of a kinetic deconvolution optical reconstruction (KDOR) method;

FIGS. 3A to 3D show a comparison of processing an image of a three-layer medium obtained via optical tomography using TS and KDOR methods;

FIGS. 4A to 4D show a comparison of processing an image of a cylindrical medium obtained via optical tomography using TS and KDOR methods;

FIGS. 5A and 5B show brain specific absorption curves obtained using the KDOR and TS methods, respectively;

FIGS. 6A and 6B show average FR(t) curves recovered with the KDOR method for extracerebral layer (ECL) and brain tissue, respectively;

FIGS. 6C and 6D show average FR(t) curves recovered with the TS method for ECL and brain tissue, respectively;

FIGS. 7A, 7B and 7C are box-and-whisker plots of blood flow, blood volume and mean transit time for ECL;

FIGS. 7D, 7E and 7F are box-and-whisker plots of blood flow, blood volume and mean transit time for brain tissue;

FIGS. 8A and 8B show attenuation curves and variance curves, respectively, at baseline, hypocapnia and ischemia conditions;

FIGS. 9A and 9B show the recovered flow-scaled impulse residue functions and the recovered brain tissue concentration curves, respectively;

FIG. 10 shows a graph of DCE NIR CBF vs. CT perfusion;

FIG. 11A is a schematic view of a fan-beam system;

FIG. 11B is a perspective view of an optical digimouse;

FIGS. 12A and 12B show the mean KDOR-recovered K₁R(t) function for the targeted and untargeted tracers, respectively,

FIGS. 12C and 12D show the mean uptake curves recovered with the TS method for the targeted and untargeted tracers, respectively;

FIGS. 13A, 13B and 13C are box-and-whisker plots of the kinetic parameters K₁, k2 and the binding potential BP recovered with the KDOR method and the TS method for the background region of the digimouse of FIG. 11B; and

FIGS. 13D, 13E and 13F are box-and-whisker plots of the kinetic parameters K₁, k2 and the binding potential BP recovered with the KDOR method and the TS method for the tumor region of the digimouse of FIG. 11B.

### DETAILED DESCRIPTION OF THE EMBODIMENTS

A method for processing optical image data obtained via optical instrumentation to recover dynamic parameters of a plurality of sub-regions is described, and is generally referred to as a kinetic deconvolution optical reconstruction (KDOR) method. The KDOR method comprises processing optical image data and measurements of a concentration of contrast agent entering an interrogation region to determine a flow-scaled impulse residue function for each of the sub-regions, and calculating dynamic parameters for each sub-region from a respective flow-scaled impulse residue function.

The contrast agent is injected into a subject to enhance the imaging of the specific interrogation region of interest. For example, the interrogation region may be biological tissue. Upon injection of the contrast agent, one or more optical sources are used to direct photons at the interrogation region. The photons pass through the interrogation region and are received by one or more optical detectors positioned at one or more positions around the interrogation region. The received photons are converted to an electrical signal by the optical detectors. The electrical signals are stored as optical image data in memory of a general purpose computing device for processing. As will be appreciated, techniques such as optical tomography or multi-distance diffuse reflectance may be used. Simultaneously, the arterial concentration of the contrast agent delivered to the interrogation region is measured using a dye densitometer or similar device. The optical imaging domain is divided into a number of sub-regions wherein the optical image data is processed via the KDOR method to determine the dynamic parameters of each sub-region. The KDOR method involves the formulation of the separate aspects of spatial or image reconstruction and of kinetic deconvolution into one mathematical expression.

Spatial or image reconstruction of optical image data following the introduction of a contrast agent into an interrogation region relates a change in an interrogation sub-region optical property caused by the contrast agent to the effect this change has on a measured optical signal. Mathematically, this is represented as:

$$Δ {S}_{i} = {\sum }_{J = 1}^{{N}_{J}} {A}_{i , j} [ {μ}_{j} ] \cdot Δ {C}_{j} \qquad ( 1 )$$

where ΔCⱼ is the change in contrast agent concentration in the j^{th} sub-region (which refers to either a layer in surface reflectance measurements or an imaging voxel in tomographic measurements), ΔSᵢ is the measured change in optical signal at the i^{th} source-detector position, and the sensitivity function, A_{i,j}, is the transformation between the change in contrast agent concentration ΔCⱼ and the measured change in optical signal ΔSᵢ and is estimated using known diffusion approximation or from Monte Carlo simulations based on an assumed set of interrogation region optical properties μⱼ.

Spatial or image reconstruction is equivalent to solving the inverse problem in Equation 1 through the use of linear or non-linear solvers. The ability to accurately reconstruct the contrast agent concentration Cⱼ depends on the amount of information and type of information contained in the measured change in optical signal ΔSᵢ and how it is related to the change in contrast agent concentration ΔCⱼ via the sensitivity function Δᵢⱼ.

As is well known, optical signals are acquired across one or more dimensions. They may be acquired spatially, through the use of multiple source-detector positions; spectrally, by employing multiple wavelengths of light; or micro-temporally, through the use of photon-counting techniques capable of determining the time-of-flight distribution of detected photons. Each of these types of measurements is used to construct a system of linear operators which can be represented in matrix form:

$$\begin{matrix}S = A \times C & ( 2 a ) \\ [ \begin{matrix}Δ {S}_{1} \\ ⋮ \\ Δ {S}_{{N}_{M}}\end{matrix} ] = [ \begin{matrix}{A}_{1 , 1} & ⋯ & {A}_{1 , {N}_{J}} \\ ⋮ & ⋱ & ⋮ \\ {A}_{{N}_{M} , 1} & ⋯ & {A}_{{N}_{M} , {N}_{J}}\end{matrix} ] \times [ \begin{matrix}Δ {C}_{1} \\ ⋮ \\ Δ {C}_{{N}_{J}}\end{matrix} ] & ( 2 b )\end{matrix}$$

where A_{i,j} is an element of a Jacobian matrix, which relates the measured optical signal Sᵢ to the change in contrast agent concentration Cⱼ in the j^{th} sub-region. As will be appreciated, the matrix S may include measurements defined for multiple dimensions, and thus may include measurements collected at different time-points, wavelengths, and spatial positions. The matrix S may also be defined for different time-of-flights or different statistical moments, when using photon-counting techniques. The number of unique signals acquired is represented as N_{M}, and the number of sub-regions in the reconstruction domain is represented as N_{J}.

The contrast agent concentration of the j^{th} sub-region Cⱼ measured over a time period is represented as a time-density curve, Cⱼ(t). The time-density curve Cⱼ(t) is represented mathematically as a convolution between the concentration of contrast agent entering an interrogation region, Cₐ(t), also called the arterial input function (AIF) and a flow-scaled impulse residue function, FⱼRⱼ(t), containing information about the specific dynamic properties of the sub-region such as for example blood flow, blood volume, mean transit time, permeability surface area product, compartmental rate constants, etc. The time-density curve Cⱼ(t) is shown as Equation 3:

$${C}_{j} ( t ) = {F}_{j} {\int }_{0}^{t} {C}_{a} ( t - u ) {R}_{j} ( u ) d u \qquad ( 3 )$$

The flow-scaled impulse residue function FⱼRⱼ(t) comprises two components—a scalar Fⱼ representing the blood flow in the interrogation sub-region, multiplied by impulse residue function Rⱼ(t) representing the fraction of contrast agent that remains in the interrogation sub-region at time t. Since impulse residue function Rⱼ(t) is equal to unity at the first appearance of contrast agent, the determination of scalar Fⱼ is readily obtained.

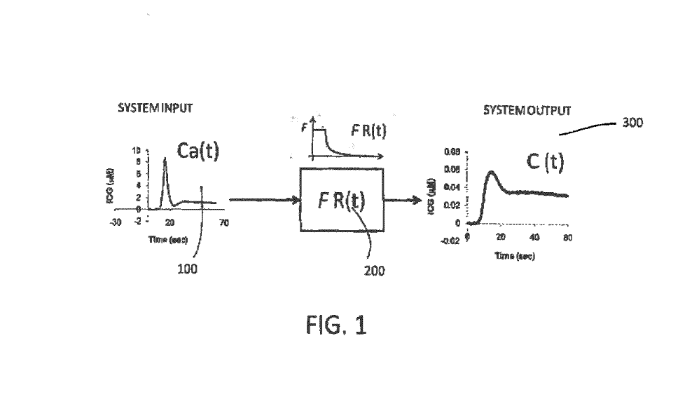

FIG. 1 shows an exemplary construction of time-density curve C(t) 300 as a convolution between the concentration of contrast agent entering an interrogation region Cₐ(t) 100 and a flow-scaled impulse residue function FR(t) 200.

The discrete representation of Equation 3 is given by:

C=C_{A}·R_{F} (4)

where C is a 1×N_{T} contrast agent concentration curve, R_{F} is a N_{A}×1 flow-scaled impulse residue function and C_{A} is a N_{T}×N_{A} Toeplitz matrix representation of the concentration of contrast agent entering the interrogation region Cₐ(t) shown as Equation 5:

$${C}_{A} = ( \begin{matrix}{C}_{a , t = 0} & 0 & 0 & ⋯⋯ & 0 \\ {C}_{a , t = 1} & {C}_{a , t = 0} & 0 & ⋮ & 0 \\ ⋮ & {C}_{a , t = 1} & {C}_{a , t = 0} & ⋮ & 0 \\ ⋮ & ⋮ & ⋮ & ⋱ & ⋮ \\ {C}_{a , t = {N}_{A} - 1} & {C}_{a , t = {N}_{A} - 2} & {C}_{a , t = {N}_{A} - 3} & ⋯ & {C}_{a , t = {N}_{A} - {N}_{T}}\end{matrix} ) \qquad ( 5 )$$

As will be appreciated, N_{T} represents the number of time-points in matrix C and N_{A} represents the number of time-points in the matrix C_{A}.

Theoretically, the N_{A}×1 flow-scaled impulse residue function R_{F} can be determined by multiplying the inverse (or more generally, the pseudoinverse in the case where N_{A}≠N_{T}) of matrix C_{A} by matrix R_{F} which is determined by minimization of the following problem:

$$arg {min}_{{R}_{F}} \{ {‖ {C}_{A} \cdot {R}_{F} - C ‖}_{2}^{2} \} \qquad ( 6 )$$

where ∥·∥ is the Euclidean norm.

In practice, however, the theoretical approach is susceptible to experimental noise and may result in a highly oscillatory solution for R_{F}. Thus, regularization or constraints are incorporated when attempting to solve Equation 6, as will now be described.

Since the flow-scaled impulse residue function FR(t) describes a real physiological system, a number of assumptions are incorporated into the constraints that are based on the known behavior of contrast agent introduced into the interrogation region.

Following the injection of contrast agent into a subject, a finite time is required for the contrast agent to reach the interrogation region from the injection site, the finite time identified as lag time, L. Therefore,

R(t)=0, t≦L (7a)

Once the contrast agent reaches the interrogation region, a minimum amount of time is required before any contrast agent exits the interrogation region—referred to as vascular minimum transit time, M. Since the impulse residue function R(t) represents the fraction of contrast agent that remains in the interrogation region as a function of time t after the injection of the contrast agent, the impulse residue function R(t) must be equal to unity during the time in which no contrast agent has left the interrogation region. Therefore,

R(t)=1, L<t≦L+M (7b)

In mammals, the circulatory system is unidirectional wherein blood enters an organ through one or more arteries, circulates within the organ, and then exits through one or more common veins. Thus, it is assumed that once a contrast agent molecule has left an organ, it will not return back to the organ through a vein, but will only return to the organ through an artery after it is recirculated by the heart. As such, the impulse residue function R(t) will never increase after the initial appearance of contrast agent. Therefore,

$$\frac{d R ( t )}{d t} \leq 0 , t > L + M \qquad ( 7 c )$$

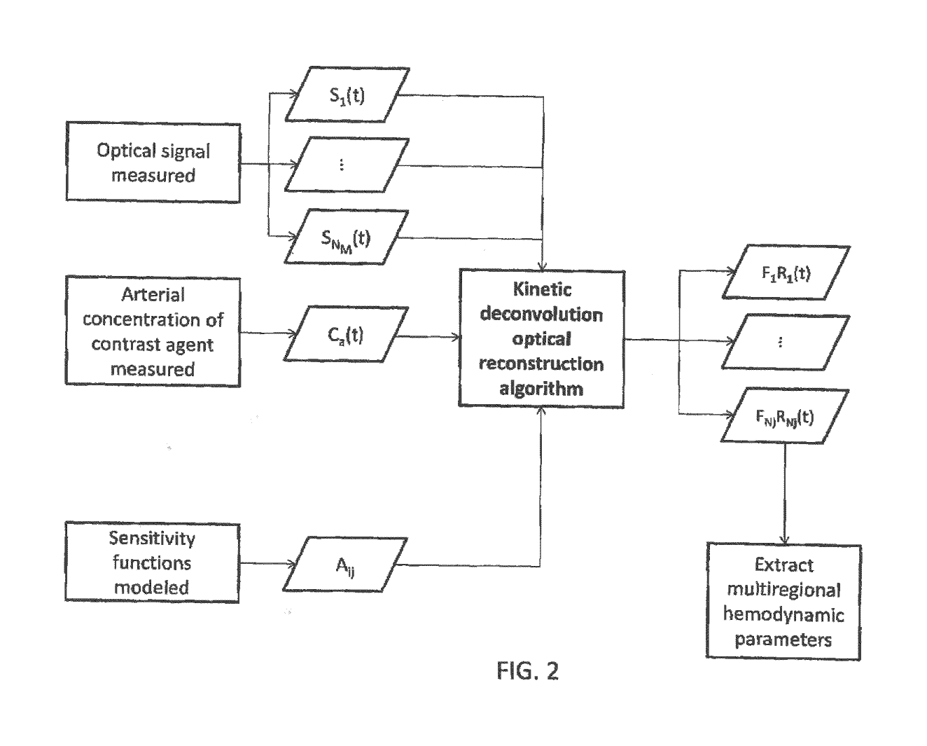

The KDOR method is shown generally in FIG. 2. As can be seen, an array of measured optical signals, the concentration of contrast agent entering an interrogation region Cₐ(t) and the sensitivity function, A_{i,j} are used to calculate region-specific flow-scaled impulse residue functions FⱼRⱼ(t). The KDOR method combines Equations 2 and 3 to provide a single step for processing optical image data to recover blood flow parameters of multiple sub-regions within the interrogation region simultaneously. Equation 3 is rewritten as:

$${C}_{j} ( t ) = {F}_{j} {\sum }_{n}^{i} {C}_{a} ( n Δ t ) {R}_{j} ( t - n Δ t ) \qquad ( 8 a )$$

where Cⱼ(t) is the region-specific time-dependent contrast agent concentration curve, Fⱼ is region-specific blood flow, Δt is the sampling time interval, and Rⱼ(t) is the region-specific impulse residue function. Equation 8a is represented in matrix form as:

Cⱼ=C_{A}×Rⱼ (8b)

where Rⱼ is the vector representation of the stacked interrogation region-specific flow-scaled impulse residue functions FjRj(t), and Cⱼ is the vector representation of the region-specific time-dependent contrast agent concentration curve Cⱼ(t).

Thus, the combination of Equation 2a and Equation 8b yields:

$$\begin{matrix}[ \begin{matrix}Δ {S}_{1} \\ ⋮ \\ Δ {S}_{{N}_{M} \times {N}_{T}}\end{matrix} ] = [ \begin{matrix}{B}_{1 , 1} & … & {B}_{1 , {T}_{A} \times {N}_{J}} \\ ⋮ & ⋱ & ⋮ \\ {B}_{{N}_{M} \times {N}_{T} , 1} & … & {B}_{{N}_{M} \times {N}_{T} , {N}_{A} \times {N}_{J}}\end{matrix} ] [ \begin{matrix}{F}_{1} {R}_{1} \\ ⋮ \\ {F}_{{N}_{A} \times {N}_{J}} {R}_{{N}_{A} \times {N}_{J}}\end{matrix} ] & ( 9 a ) \\ S = B \times {R}_{F} & ( 9 b )\end{matrix}$$

where S is a (M_{N}×T_{N})×1 linearized vector of optical measurements measured at multiple time points, R_{F} is a linearized (N_{A}×N_{J})×1 vector of stacked interrogation region-specific flow-scaled impulse residue functions, FⱼRⱼ(t), and B is a (N_{M}×N_{T})×(N_{A}×N_{J}) compartmentalized matrix comprised from the N_{T}×N_{A} Toeplitz matrix representation of the arterial concentration of contrast agent entering the interrogation region Cₐ(t) and the Jacobian matrix A relating the measured optical signal Sᵢ to the change in contrast agent concentration Cⱼ. Matrix B is given by:

$$B = [ \begin{matrix}{A}_{j = 1 , i = 1} \cdot {C}_{A} & … & {A}_{j = {N}_{j} , i = 1} \cdot {C}_{A} \\ ⋮ & ⋱ & ⋮ \\ {A}_{j = 1 , i = {N}_{m}} \cdot {C}_{A} & … & {A}_{j = {N}_{j} , i = {N}_{m}} \cdot {C}_{A}\end{matrix} ] \qquad ( 10 )$$

where C_{A} is the N_{T}×N_{A} triangular matrix described above as Equation 5.

As mentioned above, a variety of constraints are applied for stability. Generalizing the three constraints shown above as Equations 7a, 7b and 7c to the case where there are Nⱼ regions will now be described.

There are two types of constraints to be implemented, referred to as equality and inequality constraints represented by matrixes H and G, respectively. These constraints must satisfy

H·R_{F}=0 (11)

G·R_{F}=0 (12)

where matrix R_{F} can also be written as:

$${R}_{F} = [ \begin{matrix}{R}_{1} \\ {R}_{2} \\ ⋮ \\ {R}_{{N}_{J}}\end{matrix} ] \qquad ( 13 )$$

and Rⱼ is the vector representation of the stacked interrogation region-specific flow-scaled impulse residue function FⱼRⱼ(t), where t={t₁, t₁+Δt, t₁+2Δt, . . . , t_{N}_{_{A}}}.

The equality constraints are written in expanded matrix form as:

$$H = [ \begin{matrix}{h}_{1} & \tilde{0} & … & \tilde{0} \\ \tilde{0} & {h}_{2} & … & \tilde{0} \\ ⋮ & ⋮ & … & ⋮ \\ \tilde{0} & \tilde{0} & … & {h}_{{N}_{J}}\end{matrix} ] \qquad ( 14 )$$

where H is a [(L₁+Mᵢ−1)+(L₂+M₂−1)+ . . . +(Lⱼ+Mⱼ−1)]×[N_{T}×N_{J}] matrix, hⱼ is the compartment of H containing the constraint that applies only to matrix R_{F} of the j^{th} region, and \tilde{0} is a zero matrix having the dimensions for H to be properly aligned. Specifically, each zero matrix is dimensioned to have the same number of rows as the compartment row in the hⱼ matrix and the same number of columns as the compartment column in the hⱼ matrix. The constants Lⱼ and Mⱼ refer to the lag time and minimum transit time of matrix R_{F} of the j^{th} region, respectively. The compartment hⱼ is represented as:

$${h}_{j} = \begin{matrix}{L}_{j} \\ {M}_{j} - 1\end{matrix} [ \begin{matrix}\overbrace{\begin{matrix}1 & 0 & … & 0 \\ 0 & 1 & … & 0 \\ ⋮ & ⋮ & … & ⋮ \\ 0 & 0 & … & 1\end{matrix}}^{{L}_{j}} & \overbrace{\begin{matrix}0 & 0 & 0 & … & 0 & 0 \\ 0 & 0 & 0 & … & 0 & 0 \\ ⋮ & ⋮ & ⋮ & … & ⋮ & ⋮ \\ 0 & 0 & 0 & … & 0 & 0\end{matrix}}^{{M}_{j}} & \overbrace{\begin{matrix}0 & … & … & 0 \\ 0 & … & … & 0 \\ ⋮ & … & … & ⋮ \\ 0 & … & … & 0\end{matrix}}^{{N}_{T} - {L}_{j} - M} \\ \begin{matrix}0 & 0 & … & 0 \\ 0 & 0 & … & 0 \\ ⋮ & ⋮ & … & ⋮ \\ 0 & 0 & … & 0\end{matrix} & \begin{matrix}1 & - 1 & 0 & … & 0 & 0 \\ 0 & 1 & - 1 & … & 0 & 0 \\ ⋮ & ⋮ & ⋮ & … & ⋮ & ⋮ \\ 0 & 0 & 0 & … & 1 & - 1\end{matrix} & \begin{matrix}0 & … & … & 0 \\ 0 & … & … & 0 \\ ⋮ & … & … & ⋮ \\ 0 & … & … & 0\end{matrix}\end{matrix} ] \qquad ( 15 )$$

As can be seen, two non-zero compartments are present in the compartment hⱼ. The first is an identity matrix and when multiplied with matrix Rⱼ will satisfy Equation 11 only if the first Lⱼ elements of matrix Rⱼ are equal to zero. The second compartment of the second row of matrix hⱼ is the first difference operator, that is, the discrete equivalent of a first derivative. Multiplied with matrix Rⱼ, Equation 11 will be satisfied in part, only if the elements (Lⱼ+1) to (Lⱼ+Mⱼ) are equal, that is, Rⱼ is constant for a duration of time equal to the minimum transit time, Mⱼ.

Similarily, the inequality constraints are written in expanded matrix form as:

$$G = [ \begin{matrix}{g}_{1} & \tilde{0} & … & \tilde{0} \\ \tilde{0} & {g}_{2} & … & \tilde{0} \\ ⋮ & ⋮ & … & ⋮ \\ \tilde{0} & \tilde{0} & … & {g}_{{N}_{J}}\end{matrix} ] \qquad ( 16 )$$

where G is a (N_{J}×N_{T}−N_{J})×(N_{J}×N_{T}) matrix, gⱼ is the compartment of G containing the constraint that applies only to matrix R_{F} of the j^{th} region, and \tilde{0} is a zero matrix having the dimensions for G to be properly aligned. Specifically, each zero matrix is dimensioned to have the same number of rows as the compartment row in the gⱼ matrix and the same number of columns as the compartment column in the gⱼ matrix

The compartment gⱼ is represented as:

$${g}_{j} = \begin{matrix} \\ \\ \\ \\ {N}_{T} \\ \\ \\ \\ \\ \\ \\ \\ \\ {N}_{T} - 1 \\ \\ \end{matrix} [ \begin{matrix}\begin{matrix}1 & 0 & 0 & … & … & … \\ 0 & 1 & 0 & … & … & … \\ 0 & 0 & 1 & … & … & … \\ ⋮ & ⋮ & ⋮ & ⋱ & … & … \\ ⋮ & ⋮ & ⋮ & … & ⋱ & … \\ ⋮ & ⋮ & ⋮ & … & … & ⋱ \\ ⋮ & ⋮ & ⋮ & … & … & … \\ ⋮ & ⋮ & ⋮ & … & … & … \\ ⋮ & ⋮ & ⋮ & … & … & … \\ 0 & 0 & 0 & … & … & … \\ 0 & 0 & 0 & … & … & … \\ 0 & 0 & 0 & … & … & …\end{matrix} & \begin{matrix}… & … & … & 0 & 0 & 0 \\ … & … & … & 0 & 0 & 0 \\ … & … & … & 0 & 0 & 0 \\ … & … & … & ⋮ & ⋮ & ⋮ \\ … & … & … & ⋮ & ⋮ & ⋮ \\ … & … & … & ⋮ & ⋮ & ⋮ \\ ⋱ & … & … & ⋮ & ⋮ & ⋮ \\ … & ⋱ & … & ⋮ & ⋮ & ⋮ \\ … & … & ⋱ & ⋮ & ⋮ & ⋮ \\ … & … & … & 1 & 0 & 0 \\ … & … & … & 0 & 1 & 0 \\ … & … & … & 0 & 0 & 1\end{matrix} \\ \underbrace{\begin{matrix}0 & 0 & 0 & … & 0 & 0 \\ 0 & 0 & 0 & … & 0 & 0 \\ ⋮ & ⋮ & ⋮ & … & ⋮ & ⋮ \\ 0 & 0 & 0 & … & 0 & 0\end{matrix}}_{{M}_{j} + {L}_{j} - 1} & \underbrace{\begin{matrix}1 & - 1 & 0 & … & 0 & 0 \\ 0 & 1 & - 1 & … & 0 & 0 \\ ⋮ & ⋮ & ⋮ & … & ⋮ & ⋮ \\ 0 & 0 & 0 & … & 1 & - 1\end{matrix}}_{{N}_{t} - {M}_{j} - {L}_{j} + 1}\end{matrix} ] \qquad ( 17 )$$

The first row of matrix a is an identity matrix of size N_{T}×N_{T}. This constrains Rj to positive values. The first difference operator appears again in matrix gj, as the last compartment of the last row. In this case, elements (Mj+Lj−1) to (N_{T}) of matrix Rⱼ must have the property of negative monotonicity, that is, each successive element must not be greater than the previous element. As will be appreciated, this satisfies the constraint described above in Equation 7c.

Once the constraints represented by Equations 14 and 16 are constructed, matrix R_{F}, which contains flow-scaled impulse residue functions FR(t) for each sub-region, is solved with a linear solver, by the minimization:

$$arg {min}_{{R}_{F}} \{ {‖ B \cdot {R}_{F} - S ‖}_{2}^{2} \} , subject to \text{:} \begin{matrix}H \cdot {R}_{F} = 0 \\ G \cdot {R}_{F} = 0\end{matrix} \qquad ( 18 )$$

where matrix R_{F} is the combination of stacked vectors {R₁, R₂, . . . R_{NJ}}, or the equivalent functions {F₁R₁(t), F₂R₂(t), . . . F_{NJ}R_{NJ}(t)}. Thus, the blood flow of each sub-region, {F₁, F₂, . . . F_{NJ}} is recovered.

Further, integrating over FjRj(t):

$${BV}_{j} = {\int }_{0}^{NT} {F}_{j} {R}_{j} ( t ) d t \qquad ( 19 )$$

yields the blood volume, BV, of the j^{th} region, in an example where the contrast agent is confined to the intravascular space. From the central volume principle, the mean transit time MTT of the j^{th} region is calculated as BVⱼ/Fⱼ [6].

A variety of models may be applied to the recovered FⱼRⱼ(t) function, to extract additional information about the kinetic behavior, depending on the application. For example, the surface-area permeability constant of the contrast agent in the j^{th} interrogation region may be extracted by fitting Rⱼ(t) with the adiabatic approximation to a tissue homogeneity (ATH) model:

$${R}_{j} ( t ) = \{ \begin{matrix}0 & t < {L}_{j} \\ 1 & {L}_{j} \leq t < {L}_{j} {\_M}_{j} \\ E \cdot {e}^{- \frac{EF}{{V}_{e}} ( t - {M}_{j} )} & t \geq {L}_{j} + {M}_{j}\end{matrix} \qquad ( 20$$

where Mⱼ is the vascular minimum transit time, F is the blood flow, Vₑ is distribution volume of tracer in tissue, E=1−e^{-PS/F} and represents the fraction of contrast agent that diffuses into tissue during a single pass, and PS is the permeability-surface area product.

As will be appreciated, the ATH model is only one of many models that may be used to extract additional information from matrix Rⱼ. For example, while the ATH model describes the behavior of a passive contrast agent, a targeted tracer could be used in conjunction with the KDOR method and an appropriate kinetic model to determine additional parameters related to the binding of a targeted receptor in cancer cells [8].

As will be appreciated, any type of contrast agent may be identified in the above-described method such as for example indocyanine green, Omocyanine (offered by Bayer Schering Pharma, Berlin, Germany), IRDye 800CW Carboxylate (LI-COR Biosciences, Lincoln, Nebr., USA). Further, targeted contrast agents may be used to measure receptor binding potential. For example, IRDye 800CW EGF may be used to image the epidermal growth factor receptor (LI-COR Biosciences).

The KDOR method may be used in a number of optical imaging applications. For example, in addition to measuring cerebral hemodynamics, the KDOR method may also be used to assess leakage of contrast agents into brain tissue. Normally the blood-brain barrier is impermeable to contrast agents, however contrast agents such as indocyanine green are able to leak into the brain under certain pathological conditions. As such, the KDOR method may be used to monitor for intra-cerebral hemorrhage following treatment of ischemic stroke by a clot-busting drug (tissue plasminogen activator).

As another example, in optical tomography involving small-animal models, the KDOR method may be combined with targeted contrast agents. In this example, a region-specific impulse residue function could be analyzed with a kinetic model to retrieve receptor binding parameters, including the binding potential and the maximum binding concentration. One application would be to quantify the expression of specific receptors in pre-clinical cancer models.

As another example, optical tomography has been proposed as an imaging method to improve the detection of breast tumors, classify malignancy and characterize treatment response. The use of fluorescent non-targeted contrast agents, including indocyanine green or omnocyanine may be used as a means for enhancing sensitivity. The KDOR method provides a method of converting dynamic optical image data into quantitative measurements of tumor hemodynamics and vascular permeability, which are more sensitive markers of tumor types. Similar to pre-clinical studies, targeted contrast agents may be used to measure receptors that are over-expressed in tumors.

The above-described methodology may be embodied in a machine, process or article of manufacture using standard programming and/or engineering techniques to produce programming software, firmware, hardware or any combination thereof.

Any resulting program(s), having computer-readable instructions, may be stored within one or more non-transitory computer-usable media such as memory devices or transmitting devices, thereby to yield a computer program product or article of manufacture. As such, functionality may be imparted on a physical device as a computer program existent as instructions on any computer-readable medium such as on any memory device or in any transmitting device, that are to be executed by a processor.

Examples of memory devices include but are not limited to hard disk drives, diskettes, optical disks, magnetic tape, semiconductor memories such as FLASH, RAM, ROM, PROMS, and the like. Examples of networks include, but are not limited to, the Internet, intranets, telephone/modem-based network communication, hard-wired/cabled communication network, cellular communication, radio wave communication, satellite communication, and other stationary or mobile network systems/communication links.

A machine embodying the above-described methodology may comprise one or more processing systems including, for example, computer processing unit (CPU) or processor, memory/storage devices, communication links, communication/transmitting devices, servers, I/O devices, or any subcomponents or individual parts of one or more processing systems, including software, firmware, hardware, or any combination or subcombination thereof.

Examples of using the KDOR method will now be described.

### Example 1

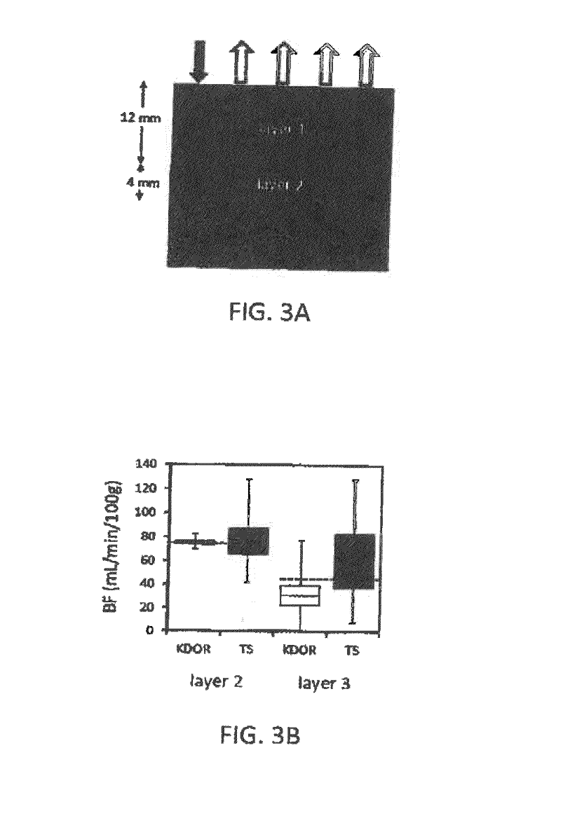

In a three-sub-region or three-layer medium, continuous-wave diffuse reflectance measurements were simulated for source-detector positions of 10, 20, 30 and 40 mm, as shown in FIG. 3A. Layer-specific sensitivity functions (i.e., mean partial path lengths) for each source-detector pair were simulated using Monte Carlo simulations [2]. The time-dependent tracer concentration was generated by convolving a simulated Cₐ(t) with layer-specific FR(t) functions generated using a gamma variant model [7]. Input F values of 10, 75 and 45 mL/min/100 g and input MT values of 12, 4, and 4.2 sec were used for layers 1, 2 and 3, respectively. Dynamic changes in μₐ for layers 1 and 2 were determined from the generated FR(t) functions assuming that the contrast agent was indocyanine green (FIG. 3C). Gaussian noise levels of 5% were added to the optical signal, Cₐ(t), and the sensitivity functions before two analytical methods were used to extract FR(t). The recovered values of F, BV, and MTT were compared with input values. The accuracy and precision of the two techniques for layers 2 and 3 are summarized as boxplots shown in FIG. 3B and were determined by repeating the procedure three hundred (300) times. The change in attenuation measured at 1 cm and 4 cm source-detector distances is shown in FIG. 3D. Better precision was observed with the KDOR technique compared to the TS technique. In both deeper tissue layers, there was an approximately five times (5×) improvement in precision. Similarly, there was a three times (3×) and one and a half times (1.5×) improvement in the precision of the MTT and BV estimates, respectively.

### Example 2

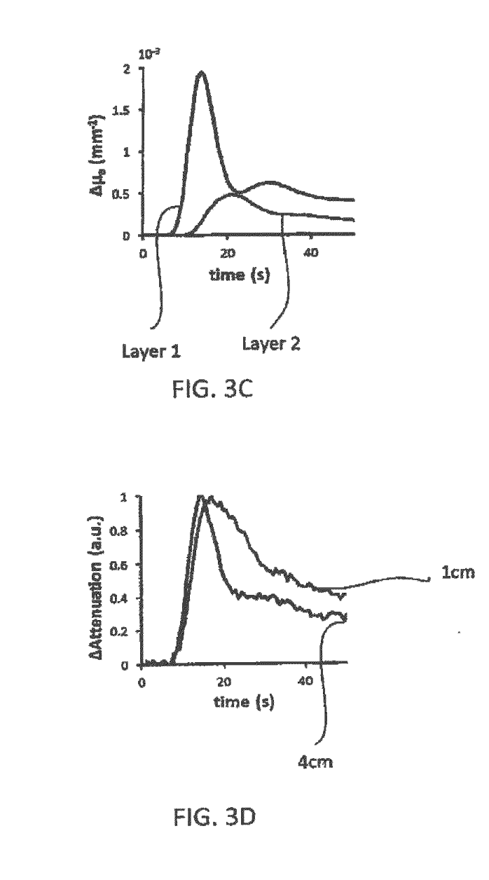

Simulations were performed using NIRFAST (Dartmouth College, NH) with fan-beam geometry (five detectors directly across from the source, spaced 22.5° apart) [5]. The contrast agent was chosen to be fluorophore. The cylindrical medium used for Example 2 comprised three hemodynamic regions and is shown in FIG. 4A. The source is illustrated as arrow AA and the detectors are illustrated as arrows BB. Fluorescence and transmission signals were simulated for sixteen (16) equally spaced projections, while the concentration of the contrast agent fluorophore was varied. Specifically, input F values of 10, 75 and 45 mL/min/100 g were used for sub-regions or layers 1, 2 and 3 (shown in FIGS. 4B), respectively. In the TS approach, fluorophore concentration maps were reconstructed independently for each time-point using the Levenberg-Marquardt minimization algorithm (the time-averaged input concentration of each pixel was used as an initial guess). Regions-of-interest were the same ones used in the forward model. The ROI-averaged CA concentration curves were then deconvolved to obtain the region-specific impulse residue functions in a single step. FIGS. 4C and 4D summarize the data and recovered functions using both approaches. Specifically, the top of FIG. 4C shows a colour map of normalized fluorescence signals for the 16 source positions measured at the 3 detector positions as a function of time during passage of the contrast agent. The bottom portion of FIG. 4C shows a sonogram for a single time point (t=16 seconds). FIG. 4D shows the true FR(t) functions for region 2 and region 3, and the recovered FR(t) functions using the TS and KDOR methods. For all regions, KDOR outperformed TS in recovering FR(t). The largest difference between the two techniques was observed in region 2, as the spatial reconstruction did a poorer job of preserving the features of this small region.

### Example 3

Numerical experiments were conducted to compare the accuracy and precision of the KDOR and TS methods. Hemodynamic input parameters used to generate the forward data were held constant for all iterations. The input parameters were blood flow (BF), blood volume (BV) and mean transit time (MTT). For the extracerebral layer (ECL), BF=5 mL/min/100 g, BV=1 mL/100 g, and MTT=12 s. For the brain, BF=50 mL/min/100 g, BV=4 mL/100 g and MTT=5 s. Reconstruction was repeated 100 times on the forward data to compare the precision of the KDOR and TS methods.

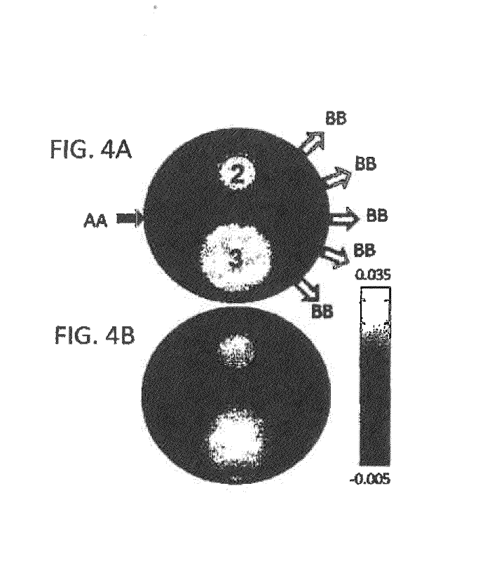

Brain specific absorption curves obtained from the TS and KDOR methods are shown in FIGS. 5A and 5B. The input curve is shown in FIGS. 5A and 5B and is identified by reference numeral 500. The change in absorption coefficient recovered with the KDOR method is shown in FIG. 5A. The KDOR absorption curve was generated by convolving the recovered FR(t) with the original arterial input function. The change in absorption coefficient recovered with the TS method is shown in FIG. 5B. The TS absorption curve was recovered in the first step of the procedure, and was then analyzed to recover the hemodynamic function.

Two differences are identified when comparing the absorption curves for the KDOR method (FIG. 5A) and the TS method (FIG. 5B). First, the TS absorption curve (FIG. 5B) shows approximately a −10% bias in the peak absorption compared to the input curve 500, whereas the KDOR absorption curve (FIG. 5A) does not show a discernible bias. In addition, the variability in the TS absorption curve (FIG. 5B) is two times greater than the variability in the KDOR absorption curve (FIG. 5A) around the absorption peak. This variability increased to five times at other time points.

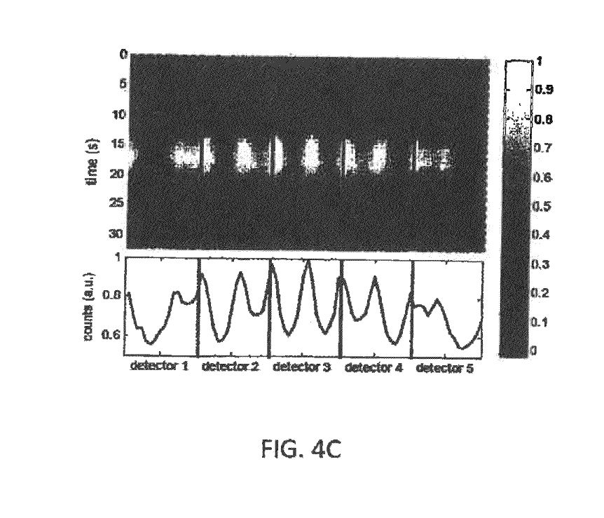

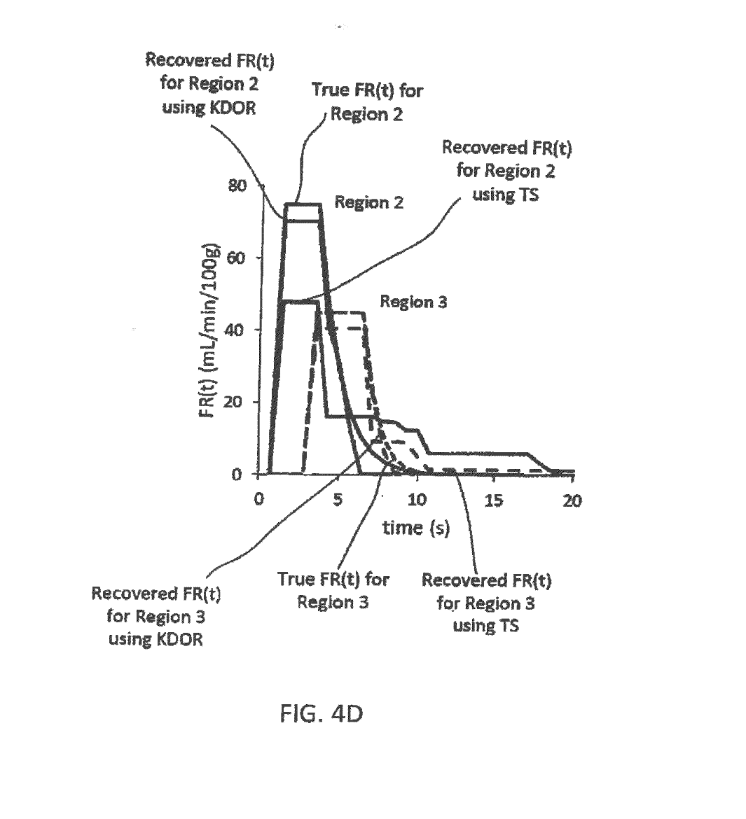

FIGS. 6A and 6B show the average FR(t) curves recovered with the KDOR method for the ECL and brain tissue, respectively. The ideal FR(t) curve is identified in FIG. 6A by reference numeral 610 and in FIG. 6B by reference numeral 620. FIGS. 6C and 6D show the average FR(t) curves recovered with the TS method for the ECL and brain tissue, respectively. The ideal FR(t) curve is identified in FIG. 6C by reference numeral 630 and in FIG. 6D by reference numeral 640

Comparing the average FR(t) curves for the ECL for the KDOR method (FIG. 6A) and for the TS method (FIG. 6C), it can be seen that the average FR(t) curves closely resemble the ideal FR(t) curves, suggesting that there is sufficient information present in the measured signal pertaining to the ECL to allow direct reconstruction with minimal regularization.

Comparing the average FR(t) curves for the brain tissue for the KDOR method (FIG. 6B) and for the TS method (FIG. 6D), it can be seen that the average FR(t) curve for the TS method did not accurately capture the shape of the top of the ideal FR(t) curve, which resulted in an underestimation of BF by 11%. The precision of the average FR(t) curves was higher for the scalp region, and higher when using the KDOR method compared to the TS method. These results suggest that any errors caused by execution of the TS method during spatial reconstruction propagate into the kinetic analysis, resulting in increased variability and an underestimation bias.

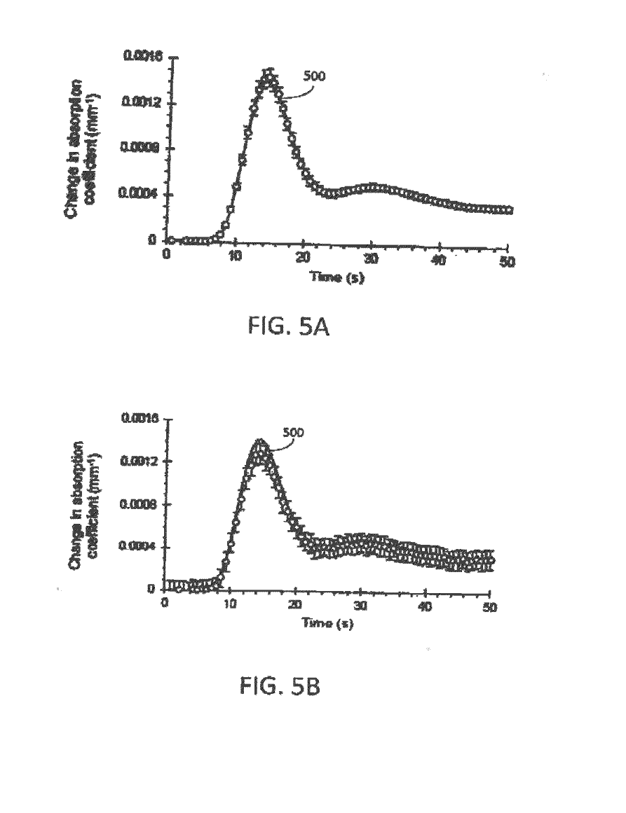

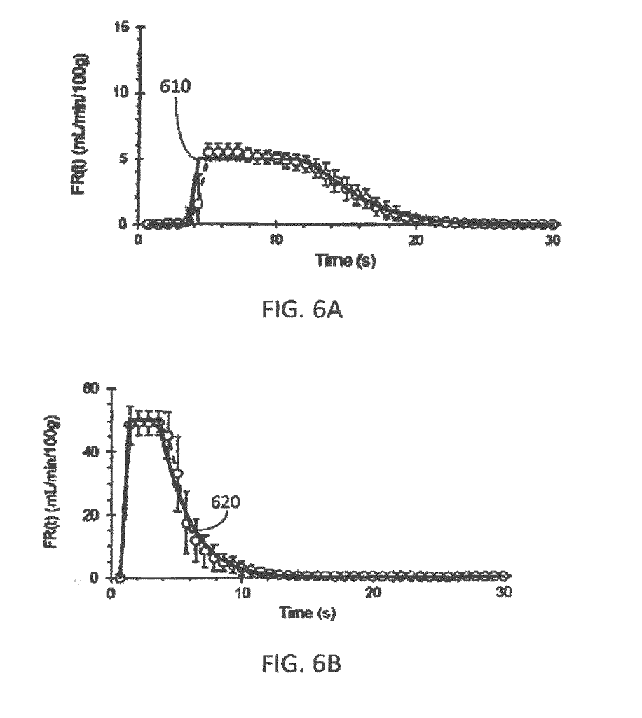

The three hemodynamic parameters of interest (BF, BV and MTT) were calculated for the two tissue regions (ECL and brain tissue) from the average FR(t) curves shown in FIGS. 6A to 6D. Box-and-whisker plots of the BF, BV and MIT for ECL are shown in FIGS. 7A, 7B and 7C, respectively. Box-and-whisker plots of the BF, BV and MTT for brain tissue are shown in FIGS. 7D, 7E and 7F, respectively. In FIGS. 7A to 7F, boxes are bound by the 1^{st} and 3^{rd} quartiles, and the median is given by the center line. Error bars are the minimum and maximum, with outliers shown in crosses. The dashed lines show the true value of the parameter.

As can be seen, the KDOR method was more accurate in recovering the hemodynamic parameters than the TS method. In particular, the mean error in recovered CBF was −1.4% using the KDOR method, compared with −11% using the TS method. The precision of the CBF estimate derived from the KDOR method was approximately two times greater than the precision derived from the TS method.

### Example 4

A Duroc-cross pig was acquired. Following induction with 1.75-3% isoflurane, the pig was tracheotomized and mechanically ventilated on oxygen/medical air. A rubber probe holder was placed on the head and fixed in place with tissue glue, and three surgical incisions were made, one each on the caudial, rostral and lateral sides of the probe holder, so that only the segment medial to the holder was left intact. This was done to reduce the blood flow in the scalp, which is much higher in the pig due to high vascularization of the thick temporalis muscles originating at the temperoparietal region of the head [9].

Following the scalp surgery, the animal was given a 1-hour stabilization period before the start of the validation experiment. DCE-NIR and CT perfusion measurements were made for each of three physiological conditions: baseline, hypocapnia, and ischemia. A DCE NIR measurement consisted of collecting multi-channel TR NIR data firom the surface of the head during the bolus injection of ICG (0.1 mg/kg, Cardiogreen, Signa-Aldrich, St. Louis, Mo.), and simultaneously acquiring the Ca(t) by dye densitometry. The CT perfusion measurement was performed following the DCE-NIR measurement. Hypocapnia was achieved by increasing the respiration rate on the ventilator, resulting in the overexpiration of CO₂ and subsequent increase in CBF as a compensatory mechanism. Ischemia was achieved by drilling a burr hole through the scalp and scull just lateral to the probe holder at the halfway point, and infusing endothelin-1 (ET-1), a potent vasoconstrictor, directly into the cortical tissue via a 30-Ga needle angled towards the midline. The objective was to cause widespread ischemia across the hemisphere beneath the probe holder.

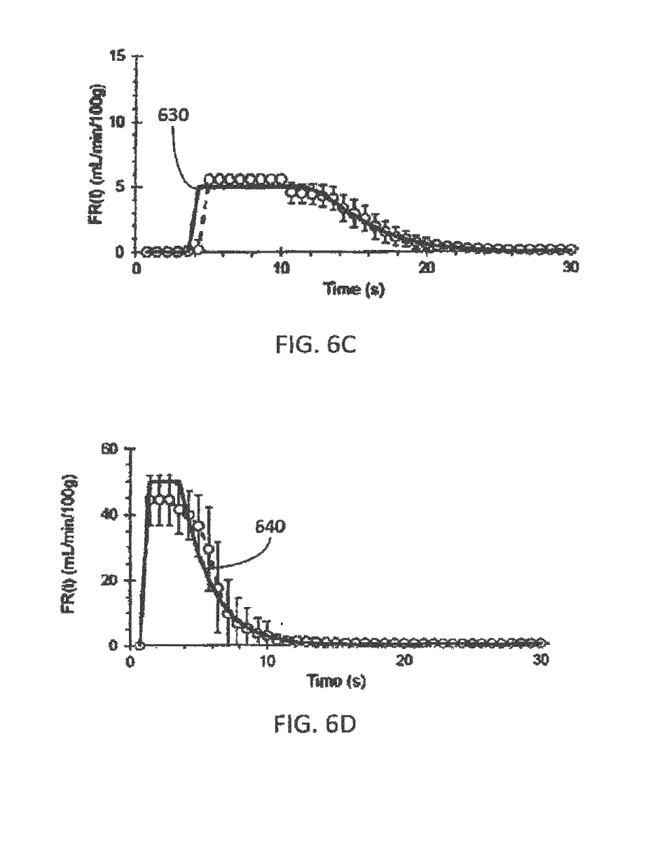

A representative example of attenuation curves at baseline, hypocapnia and ischemia conditions is shown in FIG. 8A. A representative example of variance curves at baseline, hypocapnia and ischemia conditions is shown in FIG. 8B. As can be seen, the attenuation curves exhibit little difference in shape when acquired under the three conditions, with the exception of a slight difference in the washout of dye under hypocapnia. When examining the change in variance curves, there is a significant shape difference between the ischemia curve compared with the baseline and hypocapnia curves. It is noted that under the baseline and hypocapnia conditions, the variance curve contains a significant fast component that arrives earlier than the attenuation signal, which is slow and persistent. This fast component is abolished under the ischemia condition, which affects only the blood flow in the brain tissue. This suggests that the variance curve is maximally sensitive to changes occurring in the brain.

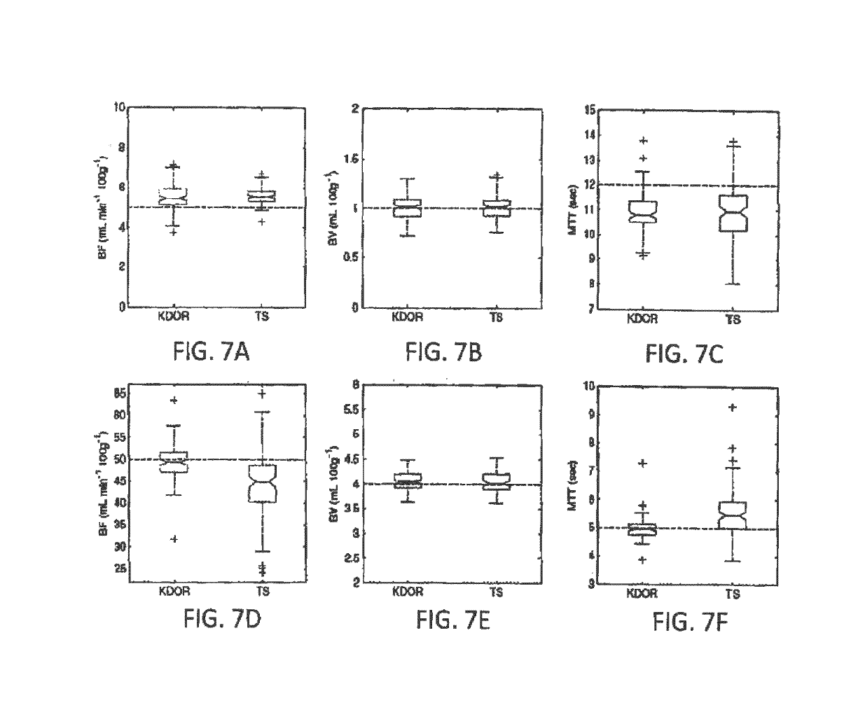

The KDOR method was used to analyze the entire data set, collected at four distances and defined for the three conditions. The recovered flow-scaled impulse residue functions FR(t) are shown in FIG. 9A. As can be seen, there is a difference in height for each of the three conditions. It is noted that the maximum height of the curves shown in FIG. 9A is equal to blood flow.

The recovered brain tissue concentration curves for the three conditions are shown in FIG. 9B. It is noted that under the baseline and hypocapnia conditions, the first pass of the dye decreased to about 15% of the maximum before recirculation caused transient fluctuations. The shape of the concentration curves is characteristic of brain dye curves under non-ischemic conditions, confirmed by measurements in piglets [10], directly on the brain of adult pigs [9] and in CT region-of-interest curves. The recovered curve under the ischemia condition shows a reduction in the amount of dye delivered to the brain tissue, and has slightly slower kinetics suggesting that flow was reduced. Quantitative comparisons were made under these three conditions with CT perfusion measurements calculated for appropriate regions-of-interest. These values are summarized in Table 1:

TABLE 1
The DCE NIR and CT perfusion recovered hemodynamic values
for baseline, hypocapnia and ischemia conditions

| | Baseline | | Hypocapnia | | Ischemia | |
|---|---|---|---|---|---|---|
| | DCE | | DCE | | DCE | |
| | NIR | CT | NIR | CT | NIR | CT |
| CBF (ml min⁻¹ 100 g⁻¹) | 75.0 | 70.1 | 61.5 | 62.9 | 27.2 | 38.1 |
| CBV (ml 100 g⁻¹) | 3.74 | 5.38 | 3.13 | 4.38 | 3.33 | 4.41 |
| MTT (sec) | 2.99 | 4.61 | 3.06 | 4.18 | 7.33 | 6.93 |

As can be seen in Table 1, for each condition, the DCE NIR and CT measurements are in agreement, however the DCE NIR measurements exhibit slightly smaller blood volumes than CT perfusion.

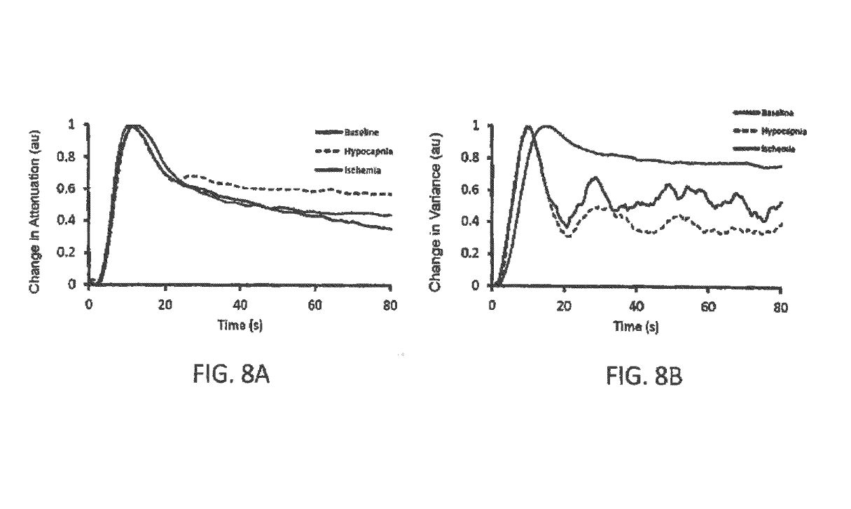

FIG. 10 shows a graph of DCE NIR CBF vs. CT perfusion. For this graph, twelve (12) measurements were taken from five (5) adult pigs.

### Example 5

The KDOR method was used to characterize the behavior of targeted tracers which bind to receptors of interest. Targeted tracer methods are used in imaging modalities such as positron emission tomography (PET) and planar fluorescence imaging to quantify molecular expression of epidermal growth factor receptor (EGFR) in tumors [11]. Similar to CT perfusion, PET molecular imaging involves two-steps: spatial reconstruction of tracer concentration and subsequent kinetic analysis. Spatial reconstruction in PET is a known problem: the radioisotope undergoes positive beta decay, and subsequent positron-electron annihilation. Producing two 511 keV gamma photons that are emitted at almost 180° can be used to localize the source of the decay with sub-centimeter resolution. However, using a two-step (TS) process in optical tomography results in loss-of-information that will decrease the accuracy of recovered kinetic parameters. As an alternative approach, the KDOR method was used to characterize the R(t) function for each region directly and to obtain information from these recovered functions by fitting them with a kinetic model.

In molecular imaging with targeted and untargeted probes, the uptake of a tracer by the tissue is described by the following convolution:

C(t)=K₁Cₐ(t)×R(t) (21)

where K₁ is the rate constant governing the extraction of the tracer into the interstitial space, Cₐ(t) is the concentration of contrast agent entering an interrogation region, and R(t) is the impulse residue function.

If an untargeted tracer is selected that has the same concentration of contrast agent entering the interrogation region Cₐ(t) as the targeted tracer, and the binding kinetics (k₃ and k₄) are faster than the vascular leakage kinetics (k₂), then the following Equations describe the impulse residue function for the targeted Rₜ(t) and untargeted Rᵤ(t) tracers:

$$\begin{matrix}{R}_{t} ( t ) = {e}^{- \frac{{k}_{2}}{1 + BP} t} & ( 22 ) \\ {R}_{u} ( t ) = {e}^{- {k}_{2} t} & ( 23 )\end{matrix}$$

where BP is the binding potential and is equal to k₃/k₄ [11].

In this example, the KDOR method was used to recover the K₁R(t) function from each region. The kinetic parameters (K₁, k₂, BP) were recovered by optimizing the following Equation:

$${min}_{{K}_{1} , {K}_{2} , BP} \{ {‖ {K}_{1} {R}_{T , rec} ( t ) - {K}_{1} {e}^{- \frac{{k}_{2}}{1 + BP} t} ‖}_{2}^{2} + {‖ {K}_{1} {R}_{U , rec} ( t ) - {K}_{1} {e}^{- {k}_{2} t} ‖}_{2}^{2} \} \qquad ( 24 )$$

Optimization was performed in MATLAB™ using the fminsearchbnd function.

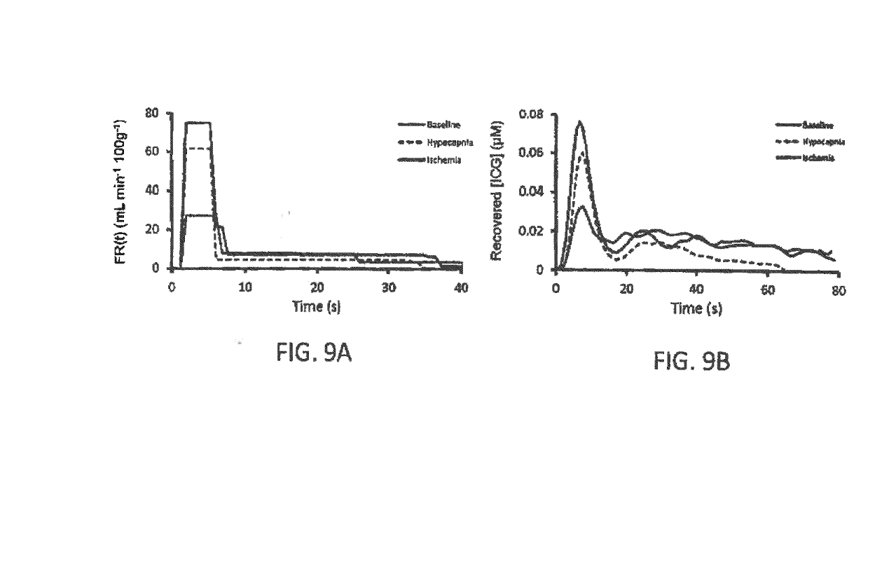

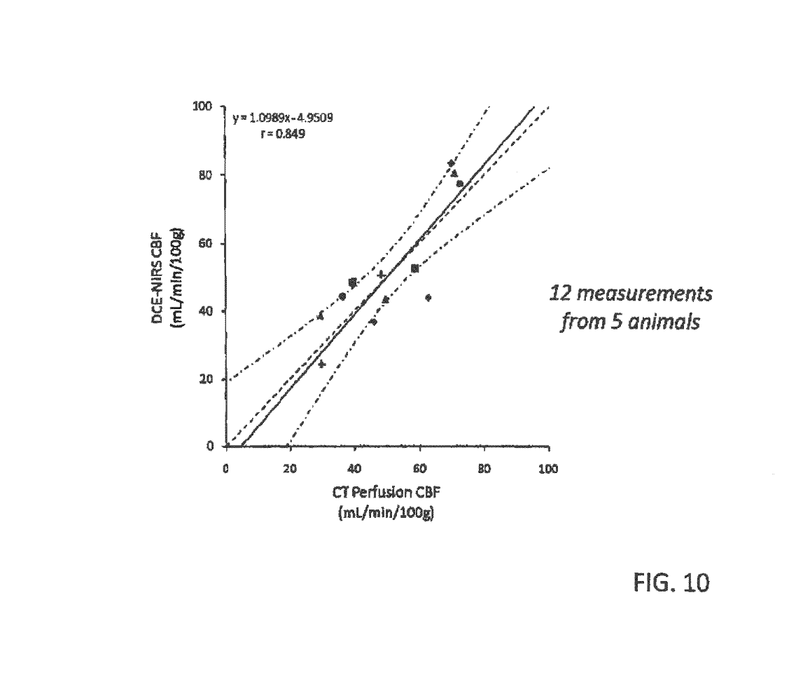

Numerical simulations were performed with NIRFAST using a heterogenous optical digimouse [12] and a fan-beam FMT system [13]. FIGS. 11A and 11B show the fan-beam system FMT 700 and the optical digimouse 800 used for the simulations. As can be seen, the fan-beam FMT system 700 comprises a source 710 and five detectors 720. The five detectors 720 rotate around a gantry 730 to collect tomography data. The optical digimouse 800 comprises a head 810 having a tumor region 820 and a background region 830.

Fluorescence at the targeted (800 nm) and untargeted (700 nm) dye wavelengths was simulated in the head 810 of the digimouse 800 and the signal was recorded in the five detectors 720 simultaneously with an integration time of 12 seconds. This was repeated for 32 source positions, with a rotation time between positions of 32 seconds. A complete set of optical data (32 source×5 detectors) was acquired every 23.5 minutes for 2.5 hours.

Reconstruction of kinetic parameters was performed using the KDOR and TS methods. For the KDOR method, the region-specific K₁R(t) functions for the targeted and untargeted tracers were reconstructed and kinetic parameters were extracted by minimizing Equation 24. For the TS method, a time-series of targeted and untargeted concentration maps were reconstructed using a Levenberg-Marquardt approach [14] with hard anatomical priors. These regions of interest were then used to define the tracer uptake curves. Kinetic parameters were extracted by fitting the tracer uptake curves with the convolution of Equation 21 (above). Reconstruction was performed on a homogeneous mesh (μₐ=0.01 mm⁻¹, μₛ′=1.0 mm⁻¹). To compare the precision and accuracy of the two approaches, the reconstruction procedure was repeated 100 times.

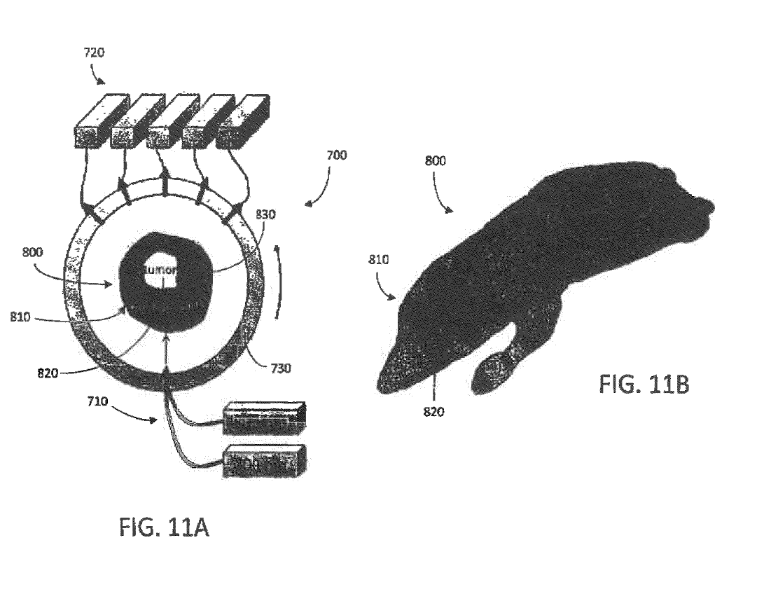

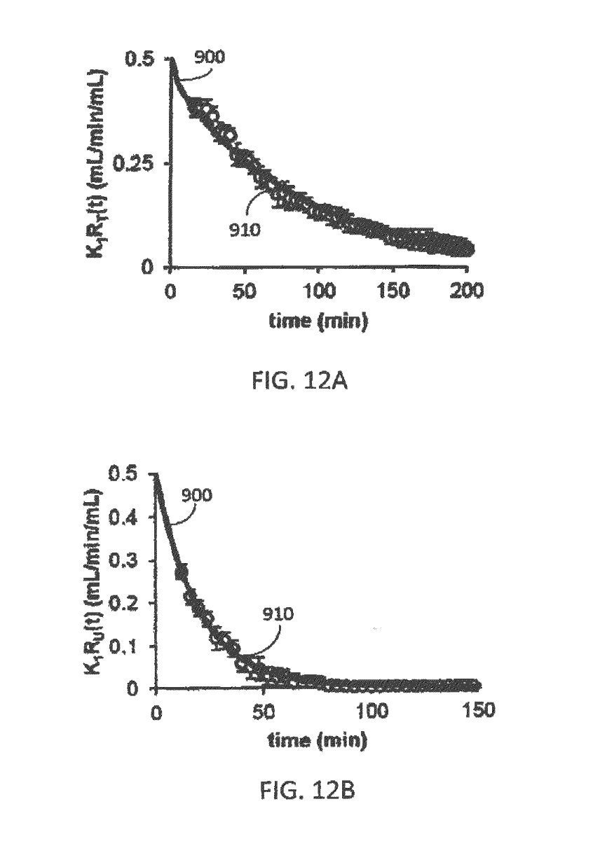

FIGS. 12A and 12B show the mean KDOR-recovered K₁R(t) function for the 100 repetitions for the targeted and untargeted tracers, respectively. The ideal K₁R(t) function is identified by reference numeral 900 and the mean model-fitted K₁R(t) function is identified by reference numeral 910.

FIGS. 12C and 12D show the mean C(t) uptake curves recovered with the TS method for the 100 repetitions for the targeted and untargeted tracers, respectively. The ideal C(t) uptake curve is identified by reference numeral 920 and the mean model-fitted uptake curve is identified by reference numeral 930.

Comparing FIGS. 12A and 12B to FIGS. 12C and 12D, it will be appreciated that the KDOR method shows a strong agreement with the ideal and mean model-fitted K₁R(t) functions. The percent difference in area under the ideal and mean model-fitted K₁R(t) functions was less than 0.01% in all cases. The uptake curve recovered using the TS method show marked deviations from the ideal and mean model-fitted uptake curves.

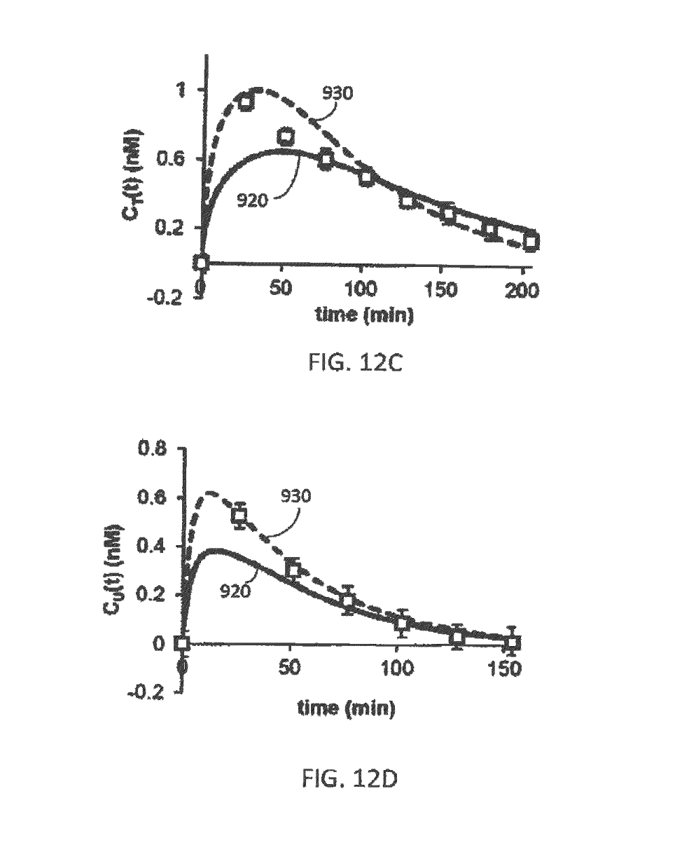

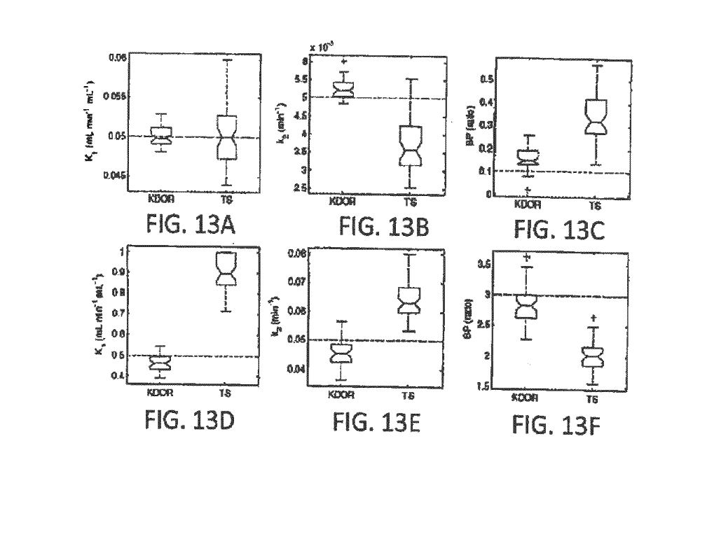

Kinetic parameters were recovered by fitting the corresponding dual-tracer model functions to these curves. Box-and-whisker plots of K₁, k2 and the binding potential BP recovered with the KDOR method and the TS method for the background region are shown in FIGS. 13A, 13B and 13C, respectively. Box-and-whisker plots of K₁, k2 and the binding potential BP recovered with the KDOR method and the TS method for the tumor region are shown in FIGS. 13D, 13E and 13F, respectively. In FIGS. 13A to 13F, boxes are bound by the 1^{st} and 3^{rd} quartiles, and the median is given by the center line. Error bars are the minimum and maximum, with outliers shown in crosses. The dashed lines show the true value of the parameter.

As can be seen in FIGS. 13A to 13F, the KDOR method is more accurate and precise in recovering the kinetic parameters K₁, k2 and the binding potential BP. The TS method is only capable of accurately recovering the background K1 parameter, and even in this case, the TS method exhibits high variability.

Although embodiments have been described above with reference to the accompanying drawings, those of skill in the art will appreciate that variations and modifications may be made without departing from the scope thereof as defined by the appended claims.

### REFERENCES

1. D. W. Brown, P. A. Picot, J. G. Naeini, R. Springett, D. T. Delpy, and T. Y. Lee. Pediatr. Res. 51 (2002).
2. J. T. Elliott, M. Diop, K. M. Tichauer, T. Y. Lee and K. St. Lawrence. J. Biomed. Opt. 15, 3 (2010).
3. A. Liebert, H. Wabnitz, J. Steinbrink, H. Obrig, M. Moller, R. Macdonald, A. Villringer and H. Rinneberg. Appl. Opt. 43, 15 (2004).
4. X. Liu, D. Wang, F. Liu, and J. Bai. Opt. Express. 18, 6 (2010).
5. F. Leblond, K. M. Tichauer, R. W. Holt, F. El-Gmussein, and B. W. Pogue. Opt. Lett. 36, 19 (2011).
6. K. L. Zierler. Circ. Res. 16 (1965).
7. H. K. Thompson, C. F. Starmer, R. E. Whalen, and H. D. McIntosh. Circ. Res. 14 (1964).
8. E. M. Hillman and A. Moore. Nat. Photonics. 1. (2007).
9. Elliott, J. T., Milej D., Gerega A., Weigl W., Diop M., Morrison L. B., Lee T-Y., Liebert A., and St. Lawrence K., “Variance of time-of-flight distribution is sensitive to cerebral blood flow as demonstrated by ICG bolus-tracking measurements in adult pigs,” Biomed. Opt. Exp. 4(2), 206-218 (2013).
10. Brown D. W., Picot P. A., Naeini J. G., Springett, R, Delpy D. T., and Lee T-Y, “Quantitative near infrared spectroscopy measurement of cerebral hemodynamics in newborn piglets,” Pediatr. Res. 51, 564-570 (2002).
11. Tichaucr K M, Samkoe K S, Klubben W S, Hasan T, Pogue B W 2012 “Advantages of a dual-tracer model over reference tissue models for binding potential measurement in tumors,” Phys Med Biol 57 6647-6659.
12. Dogdas B, Stout D, Chatziioannou A, and Leahy R M 2007 “Digimouse: A 3D Whole Body Mouse Atlas from CT and Cryosection Data,” Phys Med Biol 52(3) 577-87.
13. Tichauer K M, Samkoe K S, Klubben W S, Hasan T, Pogue B W 2012 “Advantages of a dual-tracer model over reference tissue models for binding potential measurement in tumors,” Phys Med Biol 57 6647-6659.
14. Dehghani H, Eames M E, Yalavartby P K, Davis S C, Srinivasan S, Carpenter C M, Pogue B W, Paulsen K D 2008 “Near infrared optical tomography using NIRFAST: Algorithm for numerical model and image reconstruction,” Commun Numer Methods 25(6) 711-32.

1. A method of determining dynamic parameters for a plurality of sub-regions within an interrogation region, the method comprising:
processing optical image data and measurements of a concentration of contrast agent entering each of the sub-regions to determine a flow-scaled impulse residue function for each of the sub-regions; and
calculating dynamic parameters for each sub-region from a respective flow-scaled Impulse residue function.

2. The method of claim 1 wherein the optical image data is captured upon Injection of a contrast agent.

3. The method of claim 1 wherein processing the optical image data comprises generating at least one of an equality constraint and at least one of an inequality constraint.

4. The method of claim 3 wherein the at least one equality constraint comprises at least one of:
assuming the flow-scaled impulse residue function is equal to zero prior to any portion of the contrast agent reaching a respective sub-region; and
assuming the flow-scaled impulse residue function is equal to one prior to any portion of the contrast agent exiting the respective sub-region.

5. The method of claim 4 wherein the at least one inequality constraint comprises assuming that the flow-scaled impulse residue function will decrease after any portion of the contrast agent exits the respective sub-region.

6. The method of claim 1 wherein the dynamic parameters comprise at least one of blood flow, blood volume and mean transit time.

7. The method of claim 1 wherein the contrast agent is a targeted tracer.

8. The method of claim 7 wherein the dynamic parameters comprise kinetic parameters.

9. The method of claim 8 wherein the kinetic parameters comprise at least one of a rate constant governing the extraction of the targeted tracer into an interstitial space, vascular leakage kinetics and binding kinetics.

10. The method of claim 1 wherein the interrogation region is biological tissue.

11. The method of claim 1 wherein the calculating comprises solving a matrix comprising each of the flow-scaled impulse residue functions of each of the sub-regions.

12. A non-transitory computer readable medium embodying a computer program for execution by a computer to determine dynamic parameters for a plurality of sub-regions within an interrogation region, the computer program comprising:
program code for processing optical image data and measured concentrations of a contrast agent entering each of the sub-regions to determine a flow-scaled impulse residue function for each of the sub-regions; and
program code for calculating dynamic parameters for each sub-region from a respective flow-scaled impulse residue function.

13. The non-transitory computer readable medium of claim 12 wherein the dynamic parameters comprise at least one of blood flow, blood volume and mean transit time.

14. The non-transitory computer readable medium of claim 12 wherein the contrast agent is a targeted tracer.

15. The non-transitory computer readable medium of claim 14 wherein the dynamic parameters comprises kinetic parameters.

16. The non-transitory computer readable medium of claim 15 wherein the kinetic parameters comprise at least one of a rate constant governing the extraction of the targeted tracer into an interstitial space, vascular leakage kinetics and binding kinetics.

17. An apparatus for determining dynamic parameters for a plurality of sub-regions within an interrogation region comprising:
memory embodying computer program code; and
processing structure, the processing structure communicating with the memory, the computer program code when executed by the processing structure causing the apparatus at least to:
process optical image data and measurements of a concentration of contrast agent entering each of the sub-regions to determine a flow-scaled impulse residue function for each sub-region; and
calculate dynamic parameters for each sub-region from a respective flow-scaled impulse residue function.

18. The apparatus of claim 17 wherein the dynamic parameters comprise at least one of blood flow, blood volume and mean transit time.

19. The apparatus of claim 17 wherein the contrast agent is a targeted tracer.

20. The apparatus of claim 19 wherein the dynamic parameters comprises kinetic parameters.

21. The apparatus of claim 20 wherein the kinetic parameters comprise at least one of a rate constant governing the extraction of the targeted tracer into an interstitial space, vascular leakage kinetics and binding kinetics.
